(19) United States
(12) Patent Application Publication
(10) Pub. No.: US 2003/0010528 A1
(43) Pub. Date: Jan. 16, 2003

(54) Bird resistant power line insulation

(76) Inventor: Martin S. Niles, Lac La Biche (CA)

Correspondence Address: Rodman & Rodman, 7 South Broadway, White Plains, NY, 10601, US

(21) Appl. No.: 09/902,375

(22) Filed: Jul. 10, 2001

(51) Int. Cl. H01B 17/00

(52) U.S. Cl. 174/137 A

(57) ABSTRACT

A method and apparatus for insulating high voltage electric wires from birds and other animals. A dielectric material is distributed on electrical wires or on the electric wire support at a location proximate to the wire. Such material can also be distributed on the wire to resist electric shorts when a bird contacts the electric wire and support or other wire. The dielectric properties of the material can be selected to control the distribution technique and resulting thickness of the dielectric material. The dielectric material can be distributed before installation of the electric lines or can be retrofitted to existing installations.

### BACKGROUND OF THE INVENTION

The invention relates to the field of electrical power transmission and distribution and the need to insulate electrical power lines from short circuits caused by birds and other animals. More particularly, the invention relates to an insulation method and material for coating selected portions of the structures supporting wires such as electrical transmission lines.

Long-distance electricity transmission is typically carried with high voltage conductors. Higher voltages reduce resistance power loss, and line voltage for long distance lines is stepped up with generating stations at selected locations. Transmission lines traverse large regions and require numerous support towers. The conductors in high tension powerlines are typically uninsulated because of the cost and additional weight of insulated versus uninsulated conductors.

Electric poles and towers provide attractive roosts for birds, particularly in treeless regions. If the wings of a bird simultaneously contact a transmission line and another object such as an adjacent wire, support tower or tree, the resulting electrical short-circuit can kill the bird and also damage the electrical conductor. The electrical short can further cause electrical system damage and power outages. Because large (and typically protected) birds are more susceptible to such incidental contact, electrocution hazards disproportionately affect large bird species such as raptors.

The variety and number of proposed solutions for repelling birds and other animals from electrocution risks highlights the persistence and magnitude of the problems created by such undesirable intrusion. Many different types of scarecrows and other moving devices have been developed to repel birds. For example, U.S. Pat. No. 4,131,079 to Rousseau et al. (1978) disclosed a wind operable scarecrow. U.S. Pat. No. 4,185,581 to Tilton (1980) disclosed a weight responsive perch for scaring birds. U.S. Pat. No. 4,597,357 to LeMessurier (1986) disclosed a movable aluminium sheet for scaring birds. U.S. Pat. No. 4,598,660 to Konzak (1986) disclosed an air gun for releasing a gas stream to scare birds. U.S. Pat. No. 4,656,770 to Nuttle (1987) disclosed a tiger cat weathervane. U.S. Pat. No. 4,937,988 to Gratton et al. (1990) disclosed a barrier to birds formed with monofilament line. U.S. Pat. No. 4,962,619 to Chatten (1990) disclosed a coiled wire having movable elongate flaps. U.S. Pat. Nos. 5,343,651 (1994) and 5,452,536 (1995) to Chatten disclosed a rotating carriage propelled by wind for repelling birds. U.S. Pat. No. D0359099 to Sugimoto (1995) disclosed a windmill for scaring birds, and U.S. Pat. No. 5,713,160 to Heron (1998) disclosed a retractable bird deterring device.

In addition to moving devices, various physical structures have been developed to discourage birds from roosting on structures. U.S. Pat. No. 3,407,550 to Shaw et al. (1968) disclosed spikes attached to a mounting structure. U.S. Pat. No. 4,269,008 to Assouline (1981) disclosed optical pyramid structures for generating prisms to scare birds. U.S. Pat. No. 4,845,307 to Cumming et al. (1989) disclosed a high density polyethylene wildlife guard for shielding electrical conductors at the point of attachment to an insulator bushing, and further described prior difficulties in creating an effective physical guard for such conductors. U.S. Pat. No. 5,058,335 to Richter (1991) disclosed flexible plastic fingers attachable to a wire for deterring birds. U.S. Pat. No. 5,092,088 to Way (1992) disclosed a bird deterring device having retractable wires. U.S. Pat. No. 5,253,444 to Donoho et al. (1993) disclosed a base having spikes for repelling birds, and U.S. Pat. No. 5,433,029 to Donoho et al. (1995) disclosed a channel member for clamping onto an electrical wire. U.S. Pat. No. 5,400,552 to Negre (1995) disclosed a channel base having multiple spikes for repelling birds. U.S. Pat. No. 5,454,183 to Antonini et al. (1995) disclosed a resilient base engaged with two wire mesh sections for repelling birds. U.S. Pat. No. 5,691,032 to Trueblood et al. (1997) disclosed a base having a plurality of bird repelling slots and arms extending from the base. U.S. Pat. No. 5,606,830 to Townsend, Jr. et al. disclosed grid fencing panels for attachment to electric cables or wires. U.S. Pat. No. 6,250,023 to Donoho (2001) disclosed a base having spikes for discouraging birds.

Other bird repelling concepts use electricity or magnetics to discourage bird intrusion. U.S. Pat. No. 5,255,896 to Letarte et al. (1993) disclosed an electrified fence for repelling birds. U.S. Pat. No. 5,353,543 to Teraoka (1994) disclosed a rotating magnetic field for repelling birds. U.S. Pat. No. 5,666,767 to Ohba (1997) disclosed a magnet activated by the weight of a bird to generate a bird discouraging magnetic field. U.S. Pat. No. 5,648,641 to Guthrie (1997) disclosed an electrostatically charged animal barrier. U.S. Pat. No. 5,884,426 to Ishida (1999) disclosed a wind movable magnet for generating a bird discouraging magnetic field. U.S. Pat. No. 6,006,698 to Negre (1999) disclosed electrified rails for generating vibrations for discouraging birds. U.S. Pat. No. 6,016,100 to Boyd et al. (2000) disclosed a device for generating an oscillating ultrasonic animal deterrent signal. U.S. Pat. No. 6,250,255 to Lenhardt et al. (2001) disclosed techniques which pulsated microwaves or sound waves to repel birds.

Shield and cage devices have been specifically designed to restrict birds and other animals from short-circuiting electrical leads. For example, U.S. Pat. No. 4,845,307 to Cumming et al. (1989) disclosed a high density polyethylene skirt for covering insulator bushings. U.S. Pat. No. 5,153,383 to Whited et al. (1992) disclosed a flexible sheet of PVC material attached with VELCRO strips for shielding electrical equipment. U.S. Pat. No. 6,005,196 to Spillyards (1999) disclosed a spring biased cage for covering an insulator bushing. U.S. Pat. No. 5,864,096 to Williams et al. (1999) disclosed a wildlife guard comprising a disk. U.S. Pat. No. 6,248,956 to Cook et al. (2001) disclosed an annular guard for shielding a high voltage insulator.

Materials have been developed to resist animal damage. In one example, U.S. Pat. No. 5,997,894 to Blum et al. (1999) disclosed a coating composition resistant to animals which comprised a hard, ceramic particle laden material for protecting underground wires and cables from rodents.

Various chemicals have been used to repel birds from an area or structure. U.S. Pat. No. 3,734,875 to Sekuler (1973) disclosed an aerosol bird repellent. U.S. Pat. No. 4,693,889 to Chirchirillo et al. (1987) disclosed a bird repellent composition formulated to limit stains to the structure treated. U.S. Pat. No. 5,196,451 to Greig-Smith et al. (1993), U.S. Pat. No. 5,296,226 to Askham (1994), and U.S. Pat. No. 5,549,902 to Preiser et al. (1996) disclosed other bird repellent compositions.

U.S. Pat. No. 6,226,933 to Nelson et al. disclosed a configurable sheath for protecting structures such as wires wherein the sheath could incorporate passive or active components (such as chemical repellents) for repelling animals such as birds. Nelson et al. disclosed spikes, engaged with a protective sheath, which released a noxious chemical following activation of the spikes by a bird or other animal. Nelson further disclosed that the spikes could be attached to the structure or integrated within a base material attached to the structure.

Another technique using chemical compounds to repel birds was disclosed in U.S. Pat. No. 4,873,082 to Cacioli et al. (1989) wherein a multi-layer coating comprised a brittle, polystyrene protective cover over a tacky, bird repellent layer. The outer layer prevented the accumulation of dust on the inner tacky layer. When the brittle protective cover was disturbed by a bird a noxious, bird repellent composition was released to repel the intruding bird.

The variety and number of these efforts indicate significant problems in the exclusion of birds from undesirable areas, and the inherent difficulties in effectively accomplishing such exclusion. Many of these techniques are expensive to employ and are ineffective in preventing birds from landing in a particular spot. A need exists for an improved method and apparatus capable of resisting electrical wire short circuits deleterious to birds and other animals.

### SUMMARY OF THE INVENTION

The invention provides a method and apparatus for resisting electrical shorts caused by an animal contacting an electrified wire and structure supporting the wire. The method comprises the steps of assembling a liquified dielectric material and a device for distributing said liquefied dielectric material, distributing the dielectric material on the structure at a location proximate to the electrified wire, and continuing to distribute the dielectric material on the structure until a selected dielectric material thickness is achieved. In other embodiments of the invention, the dielectric material can be distributed on the support and the wire and can be distributed by spraying and other techniques.

The apparatus comprises a support for supporting the electrified wire and a dielectric material distributed on the structure at a location proximate to the electrified wire, wherein the dielectric material has sufficient dielectric strength to resist electrical short circuits.

### BRIEF DESCRIPTION OF THE DRAWINGS

FIG. 1 illustrates a support pole for carrying high voltage electrical wires.

FIG. 2 illustrates another form of support pole.

FIG. 3 illustrates another form of support pole and a sprayer for distributing dielectric material on the selected portions of the support and wires.

### DESCRIPTION OF THE PREFERRED EMBODIMENTS

The invention provides a unique method and apparatus for resisting electrical shorts between support poles and high voltage powerlines and other electrical wires or conductors.

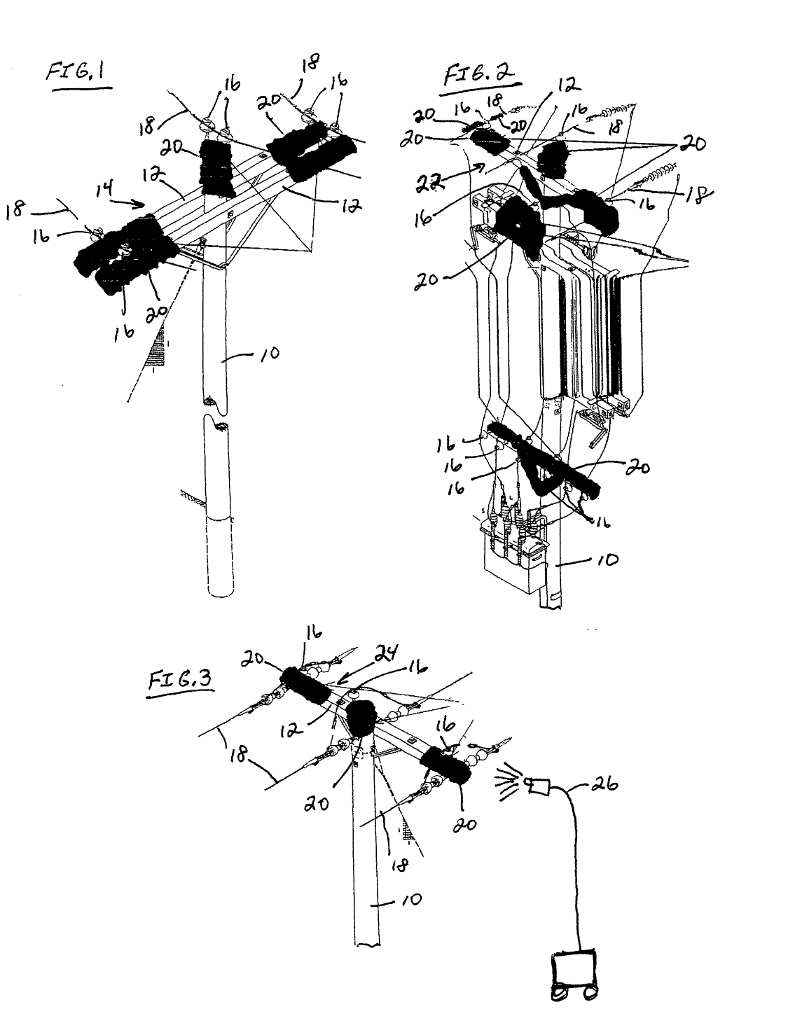

Referring to FIG. 1, pole 10 carries crossarms 12 (collectively identified as support 14) above the ground surface. Insulators 16 are attached to support 14 for carrying electrified conductors such as wires 18. Dielectric material 20 is attached to selected areas of support 14 at locations proximate to wires 18. The areal coverage and location of dielectric material on support 20 depends on the anticipated size and reach of birds and other animals potentially in contact with wires 18 and support 14.

Dielectric material 20 is defined as any material, coating, product, composition, or element, whether manufactured or naturally occurring, suitable for providing insulating capability between electrified wires 18 and an electrical ground. Specifically, such insulating strength should be sufficiently great to resist short circuits when a bird or other animal contacts wires 18 and an electrical ground such as support 14. The insulating strength of dielectric material 20 can be selected based on several factors including the voltage potential between wires 18 and support 14, the type and nature of birds and animals potentially in contact therebetween, and parameters regarding the electrical conductive contact between birds and animals within potential electric short circuits. For example, parameters useful to such evaluation include the type of contact between feathered wings and wires 18 versus the gripping strength of raptor talons in contact with support 14. Such contact in dry versus humid or wet conditions also affects the amount of insulating capability desired. Such insulating capability also depends upon the selected objectives.

Dielectric material 20 is preferably in an initial liquid state before application to support 14. This embodiment facilitates application through spraying, brushing, dipping, dabbing, or other application techniques. Dielectric material 20 can comprise a single part material or multiple part material mixed before application, and can be formulated from a combination of liquid and semi-solid or solid components.

Certain materials provide electrical insulating properties which may or may not be suitable for use by the invention. U.S. Pat. No. 5,519,080 to Matsushita et al. (1996) disclosed a silicone rubber compound for forming a water repellent, high voltage insulator. Other silicone rubber materials for forming insulators and power line bushings were disclosed in U.S. Pat. No. 5,691,407 to Azechi et al. (1997) and in U.S. Pat. No. 6,251,990 to Meguriya et al. (2001). The dielectric material 20 selected should be resistant to deterioration induced by ultraviolet light, rain, hail, temperature variations, and other environmental factors. In a preferred embodiment of the invention dielectric material is also resistant to penetration by the sharp talons of birds and the teeth of animals such as squirrels and raccoons.

In some geographic areas, the type of birds or animals typically at risk for contact with electrical wires may shift insulating emphasis away from such animals to the protection of wire 18 and support 14 assets. In other areas wherein endangered or protected birds or animals face a greater electrocution risk, the insulating strength of the dielectric material can be selected to enhance the survivability of the birds upon contact with wires 18 and support 14. Such factors can be assessed by evaluating the bird populations in the target region having behavior likely to roost on wires 18 and support 14, the nature of such roosting habits and the physical contact likely between the birds and such components, and the type of electrical short circuits desired to be protected in view of the configuration of and voltage potential between wires 18 and support 14.

In view of these factors, the dielectric strength of dielectric material 20 can be selected to resist short circuits, to eliminate potential short circuits, or to limit the amount of current flowing through such shorts to a selected range. Whereas it may not be practical to eliminate all electrical short circuits between a bird and a wire 18 or support 14, the invention provides the efficient ability to reduce to current flow to a non-life threatening level, thereby resisting electrical short circuits. The insulating capability of dielectric material 20 applied will depend on the material used as well as other parameters such as the thickness of dielectric material 20 on support 14.

In addition to installation of support 14, dielectric material 20 can also be attached to selected portions of wires 18 at locations proximate to support 14. Because wires 18 comprise one side of the electrical contacts necessary to create a short circuit when bridged by a bird or other animal, protection of such wires 18 further reduces the risk of short circuits. Either wires 18 or support 14 can be coated with dielectric material 20 to provide the electric insulating capability desired, and it would be possible to coat wires 18 exclusively at selected locations without applying any dielectric material 20 to support 14. Such technique would resist short circuits caused when the wings of a bird simultaneously contact adjacent electrified wires. By insulating both support 14 and wires 18, the thickness of dielectric material 20 covering either support 14 or wires 18 can be reduced while providing the desired dielectric strength within the potential short circuit path. Reductions in the requisite thickness of dielectric material 20 can be useful because less material is required and the time to install can be reduced.

The invention provides an apparatus having a selected dielectric material 20 applied in sufficient locations with sufficient dielectric strength to resist electrical short circuits when a bird or other animal contacts electrified wires 18. FIGS. 2 and 3 illustrate other forms of supports 22 and 24 together with possible distribution locations for dielectric material 20.

In one embodiment, the method of the invention comprises the steps of assembling a liquified dielectric material 20 and a device (shown in FIG. 3 as sprayer 26) for distributing said liquefied dielectric material, of distributing dielectric material 20 on the structure such as support 14 at a location proximate to one or more electrified wires 18, and continuing to distribute dielectric material 20 on support 14 until a selected thickness of dielectric material 20 is achieved. The device for distributing dielectric material 20 can comprise a paint brush or other conventional tool appropriate for spreading or otherwise distributing dielectric material 20.

In other embodiments of the method, dielectric material 20 can be selected to have sprayable or other specific applications properties. Such properties can account for temperature, humidity and other environmental factors anticipated for field application work. The difference in electric potential between electrified wire 18 and the support 14 can be evaluated before dielectric material 20 is sprayed on support 14, and the thickness of dielectric material 20 to provide a desired dielectric insulating capability can be assessed before application. Dielectric material 20 can be sprayed, brushed, or otherwise distributed on electrified wire 18 at selected locations proximate to support 14, and can be applied to wire 18 before wire 18 is installed on support 14 and is electrified.

One significant benefit of the invention is the flexibility and portability of the composition and installation equipment in retrofitting existing supports 14 or wires 18. Regions having bird related failures or potential for failures can be identified and targeted for application of the invention to existing powerline and other facilities. The invention accomplishes the objectives of protecting animals and reducing equipment failure while avoiding the prohibitive costs of replacing existing wires and wire supports. The invention further provides significant flexibility in application to wires and support structures having different shapes and orientations.

Although the invention has been described in terms of certain preferred embodiments, it will become apparent to those of ordinary skill in the art that modifications and improvements can be made to the inventive concepts herein without departing from the scope of the invention. The embodiments shown herein are merely illustrative of the inventive concepts and should not be interpreted as limiting the scope of the invention.

What is claimed is:

1. A method for resisting electrical shorts caused by an animal contacting an electrified wire and a structure supporting the wire, comprising the steps of:
assembling a sprayable dielectric material and a material sprayer;
spraying said dielectric material on the structure at a location proximate to the electrified wire; and
continuing to spray dielectric material on the structure until a selected dielectric material thickness is achieved.

2. A method as recited in claim 1, further comprising the step of selecting a dielectric material having sprayable properties.

3. A method as recited in claim 1, further comprising the step of evaluating the difference in electric potential between the electrified wire and the structure before said dielectric material is sprayed on the structure.

4. A method as recited in claim 1, further comprising the step of selecting the thickness of a dielectric material to provide a desired dielectric insulating capability.

5. A method as recited in claim 1, wherein said dielectric material is sprayed on the structure before the structure is installed to support the electrified wire.

6. A method as recited in claim 1, further comprising the step of spraying said dielectric material on the electrified wire at a location proximate to the structure.

7. A method as recited in claim 1, wherein said dielectric material is sprayed on the wire before the wire is supported by the structure and before the wire is electrified.

8. A method for resisting electrical shorts caused by an animal contacting an electrified wire and a structure supporting the wire, comprising the steps of:
assembling a liquified dielectric material and a device for distributing said liquefied dielectric material;
distributing said dielectric material on the structure at a location proximate to the electrified wire; and
continuing to distribute said dielectric material on the structure until a selected dielectric material thickness is achieved.

9. A method as recited in claim 8, further comprising the step of selecting the thickness of a dielectric material to provide a desired dielectric insulating capability.

10. A method as recited in claim 8, further comprising the step of evaluating the potential differential between the electrified wire and the structure.

11. A method as recited in claim 8, wherein said dielectric material is distributed on the structure before the structure is installed to support the electrified wire.

12. A method as recited in claim 8, further comprising the step of distributed said dielectric material on the electrified wire at a location proximate to the structure.

13. A method as recited in claim 12, wherein said dielectric material is distributed on the wire before the wire is supported by the structure and before the wire is electrified.

14. A method as recited in claim 8, wherein said dielectric material is distributed on the structure without de-energizing the wire.

15. A method for resisting electrical shorts caused by an animal contacting an electrified wire and another object, comprising the steps of:
assembling a liquified dielectric material and a device for distributing said liquefied dielectric material;
distributing said dielectric material on a selection portion of the wire; and
continuing to distribute said dielectric material on the wire until a selected dielectric material thickness is achieved.

16. An apparatus for supporting an electrified wire while resisting electrical shorts caused by an animal in contact with the electrified wire, comprising:
a support for supporting the electrified wire;
dielectric material distributed on the structure at a location proximate to the electrified wire, wherein said dielectric material has sufficient dielectric strength to resist electrical short circuits is contact with said dielectric material and the electrified wire.

17. An apparatus as recited in claim 16, further comprising dielectric material engaged with the electrified wire at a location proximate to said support.

18. An apparatus as recited in claim 16, wherein said dielectric material is sprayable.

19. An apparatus as recited in claim 16, wherein said dielectric material is resistant to sunlight induced deterioration.

20. An apparatus as recited in claim 16, wherein said dielectric material is resistant to deterioration induced by thermal variations.
